(19) United States
(12) Patent Application Publication
(10) Pub. No.: US 2006/0163995 A1
(43) Pub. Date: Jul. 27, 2006

(54) Gun with a cold cathode

(76) Inventors: Ningsheng Xu, Guangdong Province (CN); Jun Chen, Guangdong Province (CN); Shaozhi Deng, Guangdong Province (CN); Juncong She, Guangdong Province (CN)

Correspondence Address: THORPE NORTH & WESTERN, LLP., 8180 SOUTH 700 EAST, SUITE 200, SANDY, UT, 84070, US

(21) Appl. No.: 10/514,572

(22) PCT Filed: Dec. 30, 2002
(86) PCT No.: PCT/CN02/00921

§ 371 Date: Jul. 28, 2005

(30) Foreign Application Priority Data
May 16, 2002 (CN) 02115227.6

(51) Int. Cl. H01J 9/02

(52) U.S. Cl. 313/310

(57) ABSTRACT

This invention relates to a type of cold cathode electron gun. On the base a cold cathode made of cold cathode material is mounted. Above the cold cathode, there is a grid gate electrode. Above the gate electrode, there is a focusing electrode with round aperture. The above electrodes are insulated from each other by installing on the insulating base through supports. A grid screening electrode can be added above the focusing electrode. The screening electrode is fastened to the base by the support for screening electrode. The use of screening electrode depends on the application occasions. In small device such as light element, the screen electrode is needed, while in lighting source, the screening electron may not be necessary. The cold electron gun described in this invention has simple structure, high performance. It can be used in electron source, cold cathode lighting source and lighting element. It also can be used in occasions with similar requirements.

This patent application is a nationalization based on PCT/CN02/00921, filed Dec. 30, 2002, which claims priority to Chinese Application No. 02115227.6, filed May 16, 2002.

### TECHNICAL FIELD

This invention relates to a type of cold cathode electron gun, especially the structure of the cold cathode electron gun.

### PRIOR ART

The thermionic cathode, which is widely used currently, requires high operation temperature and needs continuous heating of the cathode. Therefore it has the disadvantage of high power consumption, being unable to instant start up and complicated electron gun structure. Cold cathode has the advantage of high current, low power consumption, high efficiency, instant start-up and quick response. Cold cathode has important application in display device, lighting source and microwave device. Usually the cold cathode electron guns have to meet the special requirement of uniformity in operation voltage, controllability and electrical insulation.

### OBJECT OF THE INVENTION

The present invention intends to provide a simple-structured and high performance cold cathode electron gun.

### TECHNICAL SOLUTION ADOPTED IN THE INVENTION

The cold cathode electron gun, as adopted in this invention, has a base, on which cold cathode made of cold cathode materials can be installed. A grid gate electrode is installed above the cold cathode. A focusing electrode with circle aperture is above the grid gate. All the electrode above-motioned are installed on the base with support and they are electrically insulated with each other.

A grid screening electrode may be installed above the focusing electrode. The screening electrode is mounted to the base by a screening electrode support.

The use of screening electrode depends on the application occasions. In small device such as light element, the screen electrode is need, while in lighting source, the screening electron may not be necessary.

The cold electron gun as described in this invention has main applications in electron source, cold cathode lighting source and lighting element. It could also be used to occasions with similar demands. This electron gun has advantage of low and uniformity operation voltage, high uniformity in emitting electron beam. The spot size can be controlled by varying the focus electrode diameter as well as its voltage. Its working principle can be described as follows. When a voltage is applied to the gate electrode, electrons are emitted from the cathode. Most electrons will pass the grid gate electrode and are focused by the focusing electrode, to which a voltage is also applied. The electron beam is emitted by passing the screening electrode. The cold cathode electron gun with above structure has been applied to cold cathode lighting source and light element and their performance has been tested. The test results show that the maximum breakdown field is 50 kV/mm, current density is 0˜1 mA/mm², operation pressure less than 1×10⁻⁴ Pa, temperature range −100˜300° C. Detailed specification for one type of cold cathode lighting element using carbon nanotube cathode is as follows: gate voltage: 1000 V, operation current: 0˜250 μA, pressure: 5×10⁻⁵ Pa, maximum luminance: 17000 cd/m2, lifetime: >100,000 hrs.

### CAPTIONS OF THE FIGURES

FIG. 1 is the schematic diagram of the structure of the electron gun;

FIG. 2 is the operation picture of a cold cathode lighting element using cold cathode electron gun as described in the present invention.

FIG. 3 is the I-V characteristics of the cold cathode electron guns as described in the present invention.

FIG. 4 is brightness vs. current and voltage characteristics of the cold cathode lighting element using electron gun as described in the present invention.

### DETAIL DESCRIPTION OF THE PREFERRED EMBODIMENT

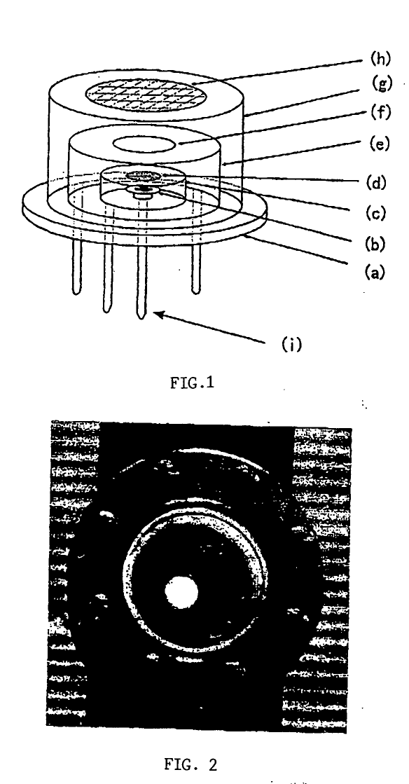

A shown in FIG. 1, the electron gun composes of base (a), cathode support (b), grid gate electrode (d), support for grid gate electrode (c), focusing electrode with round aperture (f), support for focusing electrode (e), grid screening electrode (h) and support for grid screening electrode (g).

The base is a flat insulating material; in current preferred embodiment a flat ceramic base is used. The cathode support (b), which is a circle metal plate, is installed on the base. Cold cathode material can be mounted to the cathode support by mechanical way, welding or adhesion. The cold cathode material can be tip arrays, composite cathode, carbon nanotubes, diamond or diamond-like carbon films, etc. Grid gate electrode (d) is mounted above the cold cathode (b) by the support (c) for grid gate electrode. Above the grid gate electrode, a focusing electrode (f) with round aperture is installed. Above the focusing electrode (f), a grid screening electrode (h) is mounted by installing the support (g) for grid screening electrode on the base (a). Electrical connections for all the electrodes are underneath the base (a).

Cold cathode lighting elements are the components for assembling large-area display. The cold cathode lighting element has the advantage of low power consumption, high brightness, high display quality, low cost and can be used as advertisement and video display for large room. The cold cathode lighting element requires high output current, low operation voltage, and good uniformity in operation voltage and emitting electron beam. By adopting the above-described structure and carbon nanotube cathode, lighting element is made by assembling and sealing the phosphor screen with the electrode gun.

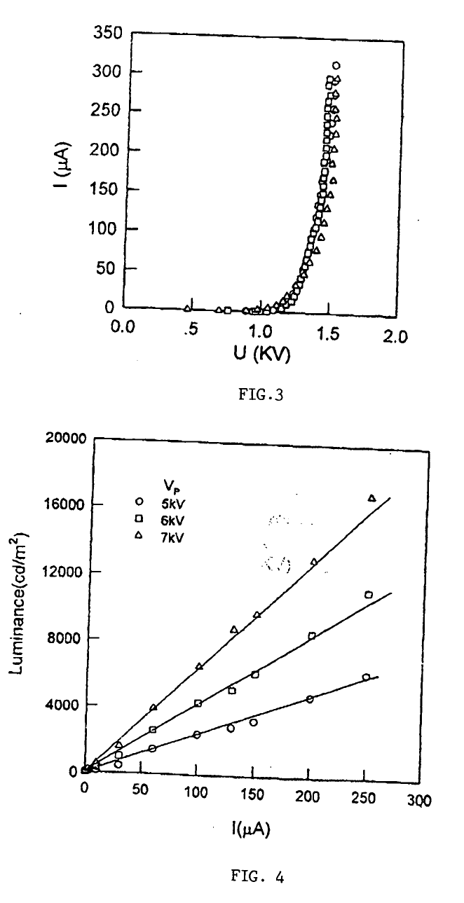

FIG. 2 is the picture showing a lighting element under operation. Uniform luminance is obtained, indicating the emitted electron beam is uniform. FIG. 3 is the I-V characteristics of the cold cathode electron guns. The results show that for different guns the operation voltage is uniform. FIG. 4 shows brightness under different cathode current and anode voltage. At the phosphor screen voltage of 7 kV and cathode current of 250 μA, the brightness of the lighting element can reach 17000 cd/m².

1. A cold cathode electron gun with following features:
Cold cathode (b) made of cold cathode material is installed on the base (a). Above the cold cathode (b), there is a grid gate electrode (d). Above the grid gate electrode (d) there is a focusing electrode with round aperture (f). The above-mentioned electrodes are fastened on the base (a) by the supports (c,e) and electrically insulated from each other.

2. A cold cathode electron gun as described in claim 1, which has feature that above the focusing electrode (f) there is a grid screening electrode (h). The screening electrode is fastened to the base (a) by a support (g).
